(19) United States
(12) Patent Application Publication
(10) Pub. No.: US 2019/0272607 A1
(43) Pub. Date: Sep. 5, 2019

(54) NACHA COMPLIANT SECURE FUND TRANSFER

(71) Applicant: AbsolutePay LLC, Bedford, NH (US)

(72) Inventors: Matthew Neuman, Bedford, NH (US); James Aguiar, Bedford, NH (US)

(73) Assignee: AbsolutePay LLC, Bedford, NH (US)

(21) Appl. No.: 16/291,595

(22) Filed: Mar. 4, 2019

Related U.S. Application Data
(60) Provisional application No. 62/638,226, filed on Mar. 4, 2018.

(51) Int. Cl. G06Q 50/16; G06Q 20/10; G06Q 20/02; G06Q 20/40

(52) U.S. Cl. CPC G06Q 50/167; G06Q 20/10; G06F 3/0481; G06Q 20/40; G06Q 20/023

(57) ABSTRACT

A transaction settlement system is disclosed that allows for transferring funds to a pre-established financial account. In an embodiment, a fund transfer application provides a user interface through which a user can initiate a transfer of funds to a pre-established financial account. The user interface allows the user to specify an amount of funds to transfer and a financial account from which to withdraw the specified amount of funds. In response to a fund transfer authorization from the user, the fund transfer application processes the fund transfer from the specified financial account to the pre-established financial account. In an embodiment, the fund transfer application using an ACH payment transaction.

### RELATED APPLICATIONS

This application claims the benefit of and priority to U.S. Provisional Application No. 62/638,226, filed on Mar. 4, 2018, which is herein incorporated by reference in its entirety.

### FIELD OF THE DISCLOSURE

This disclosure relates generally to fund transfers, and more particularly, to an integrated and secure NACHA compliant fund transfer.

### BACKGROUND

Real estate transactions typically culminate with a closing process. The closing process includes a due diligence period during which any real estate transaction contingencies present are resolved, and a settlement at which time the property title passes from the selling party to the purchasing party. Although the closing process varies slightly from state to state, a settlement agent, usually an attorney or an official from a title company, commonly oversees the closing process.

The settlement agent is appointed or agreed to by the selling and purchasing parties. As such, the settlement agent acts as an intermediary between the selling and purchasing parties. The settlement agent ensures that all documents are signed and properly recorded, and all funds, including closing fees and escrow payments, are paid and properly disbursed.

### BRIEF DESCRIPTION OF THE DRAWINGS

FIG. 1 is a block diagram schematically illustrating selected components of an example networked computer system that can be used to transfer funds to a pre-established financial account, in accordance with an embodiment of the present disclosure.

FIG. 2 is a flow diagram illustrating an example process that can be used by a user to request a transfer of funds, in accordance with an embodiment of the present disclosure.

FIG. 3 is a flow diagram illustrating an example process for processing a transfer of funds to a pre-established financial account, in accordance with an embodiment of the present disclosure.

FIG. 4 is a screenshot illustrating an example fund transfer interface, in accordance with an embodiment of the present disclosure.

FIG. 5 is a screenshot illustrating the example fund transfer interface of FIG. 4 with the select account type pull-down menu expanded, in accordance with an embodiment of the present disclosure.

FIG. 6 is a screenshot illustrating the example fund transfer interface of FIG. 4 with the optional notification pull-down menu expanded, in accordance with an embodiment of the present disclosure.

FIG. 7 is a screenshot illustrating the example fund transfer interface of FIG. 4 with a completed fund transfer authorization statement, in accordance with an embodiment of the present disclosure.

FIG. 8 is a screenshot illustrating an example link account interface, in accordance with an embodiment of the present disclosure.

FIG. 9 is a screenshot illustrating an example logon screen interface for ACME Bank, in accordance with an embodiment of the present disclosure.

FIG. 10 is a screenshot illustrating an example account selection interface for ACME Bank, in accordance with an embodiment of the present disclosure.

FIG. 11 is a screenshot illustrating an example authorization confirmation feature, in accordance with an embodiment of the present disclosure.

FIG. 12 is a screenshot illustrating an example valid fund transfer submission notification, in accordance with an embodiment of the present disclosure.

FIG. 13 is a screenshot illustrating an example data entry error notification, in accordance with an embodiment of the present disclosure.

These and other features of the present embodiments will be understood better by reading the following detailed description, taken together with the figures herein described.

### DETAILED DESCRIPTION

As noted above, the real estate transaction closing process concludes in a settlement where the selling party and the purchasing party conclude the financial arrangements pertinent to the transaction including the exchange of property ownership. Both the selling party and the purchasing party perform certain actions to allow the actual settlement to take place. For example, at or before settlement, the selling party executes and delivers to the settlement agent certain documents including a deed conveying title to the property to the purchasing party, and the purchasing party delivers to the settlement agent the funds sufficient to purchase the property and to pay the purchaser's share of the closing costs. Typically, such funds are delivered to the settlement agent in the form of bank certified funds, such as a certified check, or by a wire transfer.

Although a certified check is guaranteed by a bank, the bank can refuse to cash the certified check, stop payment on the certified check, or otherwise make it difficult for a person presenting the certified check to obtain payment. Further, in some cases, the certified check may be revoked by the payor (e.g., the purchasing party). In other cases, there is the possibility that a certified check is counterfeit. Thus, certified checks may not provide the necessary irrevocable form of tender sought by the settlement agent or the selling party. In this regard, wire transfers cannot be reversed and, thus, provide the necessary irrevocable form of tender sought by the settlement agent or the selling party. Wire transfers, however, may be a concept that is still exotic and foreign to many people. For example, to make an online or electronic wire transfer, a user is required to provide information regarding the sender of the funds (e.g., name and address of the sender), amount of funds to send, information regarding a source account from which to withdraw the specified amount, information regarding the receiver of the funds (e.g., name and address of the receiver), and information regarding a destination account into which to deposit the specified amount. Thus, the extensive amount of information required to send a wire transfer affords numerous opportunities for data entry errors to a person unfamiliar with wire transfers. Also, requiring information regarding the destination account to receive the funds provides an unscrupulous or bad actor the opportunity to undertake a fraudulent act. For example, the bad actor can alter the destination account information to cause the transfer of funds to be made to an account that is different from the account intended by the user.

Thus, and in accordance with an embodiment of the present disclosure, techniques are disclosed that allow for secure and irrevocable transfer of funds from a source account to a destination account. The techniques may further provide support for integration with the user's financial institution in order to assist with providing information necessary to initiate the transfer of funds. In one example embodiment, the techniques are implemented in the context of a real estate transaction settlement service that allows a purchasing party to a given real estate transaction to transfer funds pertinent to the settlement of the real estate transaction to a settlement agent. To transfer funds to the settlement agent, the purchasing party or user is not required to provide or otherwise submit any information regarding the financial account of the settlement agent. Rather, the user simply provides his or her identification, such as a name, an amount to transfer, and identifying information of a source account from which to withdraw the funds. Once the user authorizes the transfer of the specified amount, the techniques generate a National Automated Clearing House Association (NACHA) file and sends or otherwise provides the NACHA file to the Automated Clearing House (ACH) Network for processing. In such embodiments, the NACHA file executes an Automated Clearing House (ACH) payment transaction to transfer the specified amount of funds from the source account specified by the user to a pre-established financial account of the settlement agent.

In more detail, and in accordance with an embodiment of the present disclosure, a transaction settlement system is programmed with or otherwise includes a fund transfer application that is configured to provide a user interface through which a user can initiate a transfer of funds. For example, using such user interface, a purchasing party to a given real estate transaction can access the transaction settlement system and transfer funds from his/her financial account to a pre-established financial account. In one embodiment, the fund transfer application is configured to process a requested fund transfer using an ACH payment transaction.

In some embodiments, the fund transfer application provides a feature that allows the user to link to one of the user's financial institutions. In such embodiments, the user can select a financial institution, logon to the selected financial institution by providing the necessary credentials, and access his/her financial account information via the fund transfer application. In such cases where the user links to a financial institution, the fund transfer application is configured to retrieve or otherwise extract appropriate financial account information via the user's link to the financial institution.

The disclosed techniques provide numerous advantages over previous techniques for transferring funds. For example, and according to an embodiment, the various techniques disclosed herein reduce the amount of information that a user needs to provide to transfer funds from a source account to a destination account. In such embodiments, the user need not provide identifying information of the destination account. Thus, unlike the previous fund transfer techniques that required specifying a destination account, a system configured in accordance with an embodiment of the present disclosure specifies or otherwise is configured to provide a pre-established financial account into which the funds are to be deposited. This increases security and decreases the level of data entry effort required to perform the fund transfer In addition, the disclosed techniques, according to some embodiments, allow a user to access a financial institution in order to verify and/or obtain information necessary to initiate a transfer of funds. In any such cases, the disclosed techniques significantly reduce the possibility of data entry errors and/or exposure to fraudulent or otherwise unscrupulous acts with respect to the transfer of funds. These and other advantages and alternative embodiments will be apparent in light of this disclosure.

System Architecture

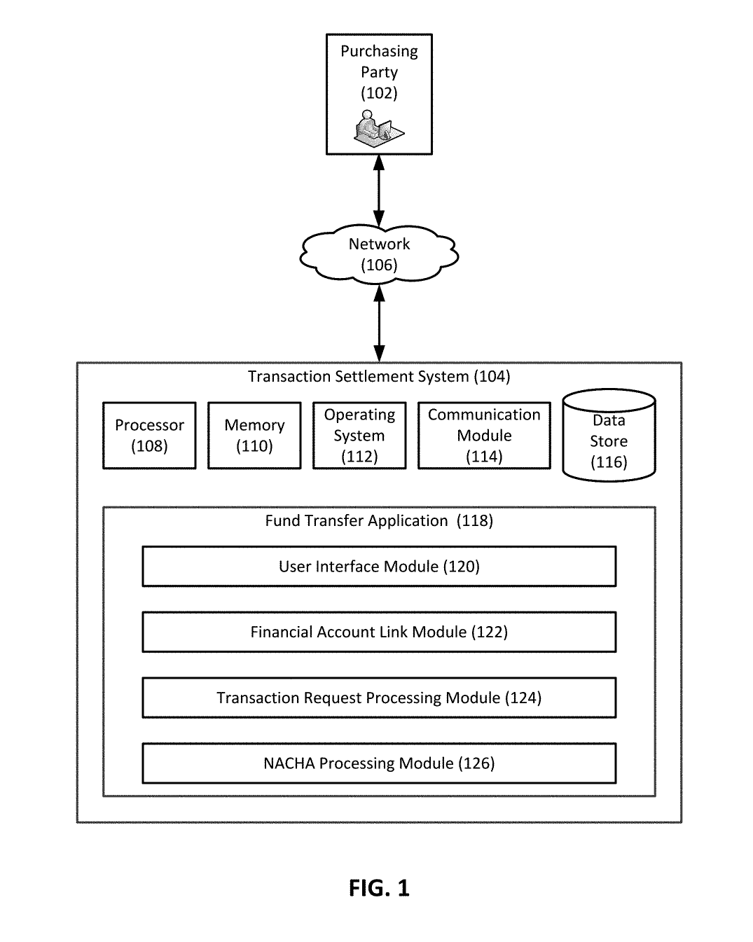

FIG. 1 is a block diagram schematically illustrating selected components of an example networked computer system that can be used to transfer funds to a pre-established financial account, in accordance with an embodiment of the present disclosure. More specifically, the system illustrated in FIG. 1 can be understood as enabling a purchasing party 102 to leverage the services of a transaction settlement system 104. For instance, purchasing party 102 can use the services of transaction settlement system 104 to securely transfer funds to a pre-established financial account of the settlement agent. Once the funds are transferred to the pre-established financial account, these funds can be applied to the settlement of a real estate transaction being made by purchasing party 102, for instance. In such embodiments, purchasing party 102 can communicate with transaction settlement system 104 via a network 106. Network 106 can also be used to access supplementary services and resources, some of which may (or may not) be integrated into and provided by transaction settlement system 104 in some cases. For example, network 106 can be used to access the ACH Network and web sites and/or servers of financial institutions, as appropriate. Thus, other embodiments may have fewer or more networks, services, and/or resources depending on the granularity of implementation. It will therefore be appreciated that the embodiments disclosed herein are not intended to be limited to the provision or exclusion of any particular services and/or resources.

Network 106 may be a local area network (such as a home-based or office network), a wide area network (such as the Internet), a peer-to-peer network (such as a Bluetooth connection), or a combination of such networks, whether public, private, or both. In certain embodiments, at least a portion of the functionality associated with network 106 is provided by a cellular data network, thereby making it easier for users of mobile computing devices to leverage the services of transaction settlement system 104. In general, communications amongst the various entities and resources described herein may occur via wired or wireless connections, such as may be provided by Wi-Fi or mobile data networks.

As illustrated in FIG. 1, purchasing party 102 has access to a device that facilitates interaction with components of transaction settlement system 104 illustrated in FIG. 1 or are otherwise described herein. For example, in certain embodiments, purchasing party 102 has access to one or more of a variety of suitable computing devices, including devices such as desktop computers, laptop computers, workstations, enterprise class server computers, handheld computers, tablet computers, cellular telephones, smartphones, and set-top boxes. Other devices may be used in other embodiments. The device or devices used by purchasing party 102 optionally include a wired and/or wireless communication adapter that enables communication via network 106. The device or devices also optionally include input/output components such as one or more of a tactile keyboard, a display, a touch sensitive display, a microphone, a camera, and location services. Such input/output components allow purchasing party 102 to not only control operation of its own device, but also to control certain operational aspects of transaction settlement system 104.

Referring still to the example embodiment illustrated in FIG. 1, transaction settlement system 104 can be configured to facilitate the secure and irrevocable transfer of funds from a source account to a pre-established destination account. Transaction settlement system 104 is also configured to provide designated parties just-in-time or near just-in-time notifications regarding the status of a fund transfer. In some embodiments, transaction settlement system 104 is also configured to facilitate integration with a specified financial institution, such as a financial institution of purchasing party 102, in order to assist with providing information necessary to initiate a transfer of funds. To this end, in one embodiment, transaction settlement system 104 includes one or more software modules configured to implement certain of the functionalities disclosed herein, and optionally further includes hardware configured to enable such implementation. This hardware and/or software may include, but is not limited to, a processor 108, a memory 110, an operating system 112, a communication module 114, and a data store 116.

Processor 108 may be designed to control the operations of the various other components of transaction settlement system 104. Processor 108 may include any processing unit suitable for use in transaction settlement system 104, such as a single core or multi-core processor. In general, processor 108 may include any suitable special-purpose or general-purpose computer, computing entity, or computing or processing device including various computer hardware, or firmware, and may be configured to execute instructions, such as program instructions, stored on any applicable computer-readable storage media. For example, processor 108 may include a microprocessor, a central processing unit (CPU), a microcontroller, a digital signal processor (DSP), an application-specific integrated circuit (ASIC), a Field-Programmable Gate Array (FPGA), Complex Instruction Set Computer (CISC), Reduced Instruction Set Computer (RISC), multi core, or any other digital or analog circuitry configured to interpret and/or to execute program instructions and/or to process data, whether loaded from memory or implemented directly in hardware. Although illustrated as a single processor in FIG. 1, processor 108 may include any number of processors and/or processor cores configured to, individually or collectively, perform or direct performance of any number of operations described in the present disclosure.

Memory 110 may include computer-readable storage media configured for carrying or having computer-executable instructions or data structures stored thereon. Such computer-readable storage media may include any available media that may be accessed by a general-purpose or special-purpose computer, such as processor 108. By way of example, and not limitation, such computer-readable storage media may include non-transitory computer-readable storage media including Random Access Memory (RAM), Dynamic Random Access Memory (DRAM), Synchronized Dynamic Random Access Memory (SDRAM), Static Random Access Memory (SRAM), non-volatile memory (NVM), or any other suitable storage medium which may be used to carry or store particular program code in the form of computer-executable instructions or data structures and which may be accessed by a general-purpose or special-purpose computer. Combinations of the above may also be included within the scope of computer-readable storage media.

Operating system 112 may comprise any suitable operating system, such as UNIX®, LINUX®, MICROSOFT® WINDOWS® (Microsoft Crop., Redmond, Wash.), GOOGLE® ANDROID™ (Google Inc., Mountain View, Calif.), APPLE® iOS (Apple Inc., Cupertino, Calif.), or APPLE® OS X® (Apple Inc., Cupertino, Calif.). As will be appreciated in light of this disclosure, the techniques provided herein can be implemented without regard to the particular operating system provided in conjunction with transaction settlement system 104, and therefore may also be implemented using any suitable existing or subsequently developed platform.

Communication module 114 can be any appropriate network chip or chipset which allows for wired or wireless communication via a network or networks, such as network 106 for instance, to one or more of the other components described herein. Communication module 114 can also be configured to provide intra-device communications via a bus or an interconnect.

Data store 116 may include any type of computer-readable storage media configured for short-term or long-term storage of data. By way of example, and not limitation, such computer-readable storage media may include a hard drive, solid-state drive, Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), non-volatile memory (NVM), or any other storage medium, including those provided above in conjunction with memory 110, which may be used to carry or store particular program code in the form of computer-readable and computer-executable instructions, software or data structures for implementing the various embodiments as disclosed herein and which may be accessed by a general-purpose or special-purpose computer. Combinations of the above may also be included within the scope of computer-readable storage media. Data store 116 may be provided on transaction settlement system 104 or provided separately or remotely from transaction settlement system 104.

Referring again to the example embodiment illustrated in FIG. 1, transaction settlement system 104 further includes a fund transfer application 118, which includes a user interface module 120, a financial account link module 122, a transaction request processing module 124, and a NACHA processing module 126. User interface module 120 is configured to provide a user interface (or interfaces) that is capable of displaying information to, and receiving information from, a user of transaction settlement system 104. For example, in one implementation, user interface module 120 provides a fund transfer interface that is capable of receiving input that defines a new fund transfer request. The fund transfer interface is also capable of displaying a fund transfer authorization statement authorizing the transfer of funds from a specified financial account. User interface module 120 is further configured to provide notification interfaces that provide error and/or warning messages with respect to information input or otherwise provided to the funds transfer interface, and optionally, suggestions as to correcting input errors. Still other interfaces can be implemented in other embodiments, including interfaces configured to allow integration with and access to a financial institution, such as a financial institution of purchasing party 102, for example.

The various interfaces generated by user interface module 120 can be rendered using hardware components associated with an end user's computer. Thus, for example, purchasing party 102 can use input/output components associated with his/her computing device to leverage services provided by user interface module 120, and in particular, to display and interact with the user interfaces generated by user interface module 120. Examples of input/output components that can be used in this regard include a display, a keyboard, a pointing device, and a touch sensitive surface. Such components can be peripheral to an end user's computing device or can be integrated into such device.

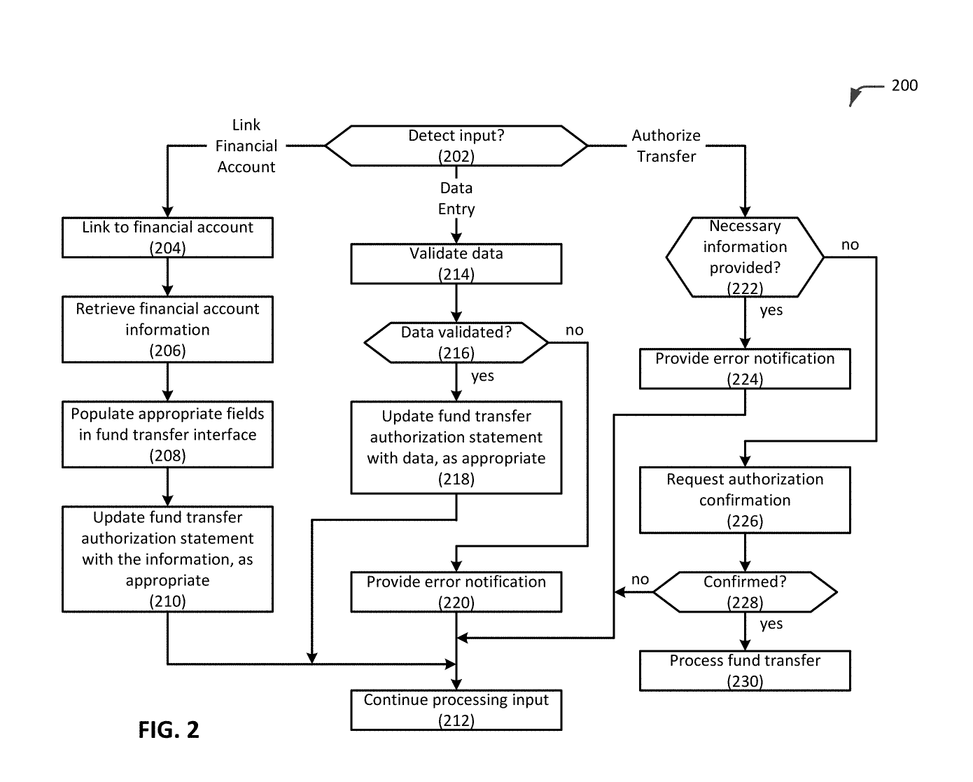

As described in further detail with respect to FIGS. 2-13, fund transfer application 118 is generally configured to facilitate the generation of a fund transfer request and the processing of a transfer of funds based on the fund transfer request utilizing the services and functionality of user interface module 120, financial account link module 122, transaction request processing module 124, and NACHA processing module 126, as necessary. Briefly, in overview, financial account link module 122 is configured to facilitate access to a financial institution website, such as a bank website. Transaction request processing module 124 is configured to process inputs provided via the fund transfer interface and generate a NACHA file based on such inputs. NACHA processing module 126 is configured to process a transfer of funds based on a NACHA file generated by transaction request processing module 124, for instance.

The embodiments described herein can be implemented in various forms of hardware, software, firmware, or special purpose processors. For example, in one embodiment, a non-transitory computer readable medium includes instructions encoded thereon that, when executed by one or more processors, cause aspects of transaction settlement system 104 described herein to be implemented. The instructions can be encoded using any suitable programming language, such as C, C++, object-oriented C, Java, JavaScript, Visual Basic .NET, BASIC, Scala, or alternatively, using custom or proprietary instruction sets. Such instructions can be provided in the form of one or more computer software applications or applets that are tangibly embodied on a memory device, and that can be executed by a computer having any suitable architecture. In one embodiment, the system can be hosted on a given website and implemented, for example, using JavaScript or another suitable browser-based technology to render, for example, the user interface screens described herein.

The functionalities disclosed herein can optionally be incorporated into a variety of different software applications and systems, including payment applications, payment systems, money transfer applications, escrow payment applications, and real estate transaction management systems, to name a few examples. The functionalities disclosed herein can additionally or alternatively leverage services provided by separate software applications and systems. For example, in one embodiment, the functionalities disclosed herein can be implemented in a cloud environment, such as Microsoft® Azure®, AWS®, Google Cloud™, or any suitable cloud environment. Additionally or alternatively, the functionalities disclosed herein can be implemented using an IaaS framework. The computer software applications disclosed herein may include a number of different modules, sub-modules, or other components of distinct functionality, and can provide information to, or receive information from, still other components and services. These modules can be used, for example, to communicate with input/output devices such as a display screen, a touch sensitive surface, auditory interface, a digital camera, or any other suitable input/output device. Other components and functionality not reflected in the illustrations will be apparent in light of this disclosure, and it will be appreciated that the present disclosure is not intended to be limited to any particular hardware or software configuration. Thus, in other embodiments, the components illustrated in FIG. 1 may include additional, fewer, or alternative subcomponents.

In alternative embodiments, the computers and modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present disclosure is not intended to be limited to any particular system architecture.

Methodology

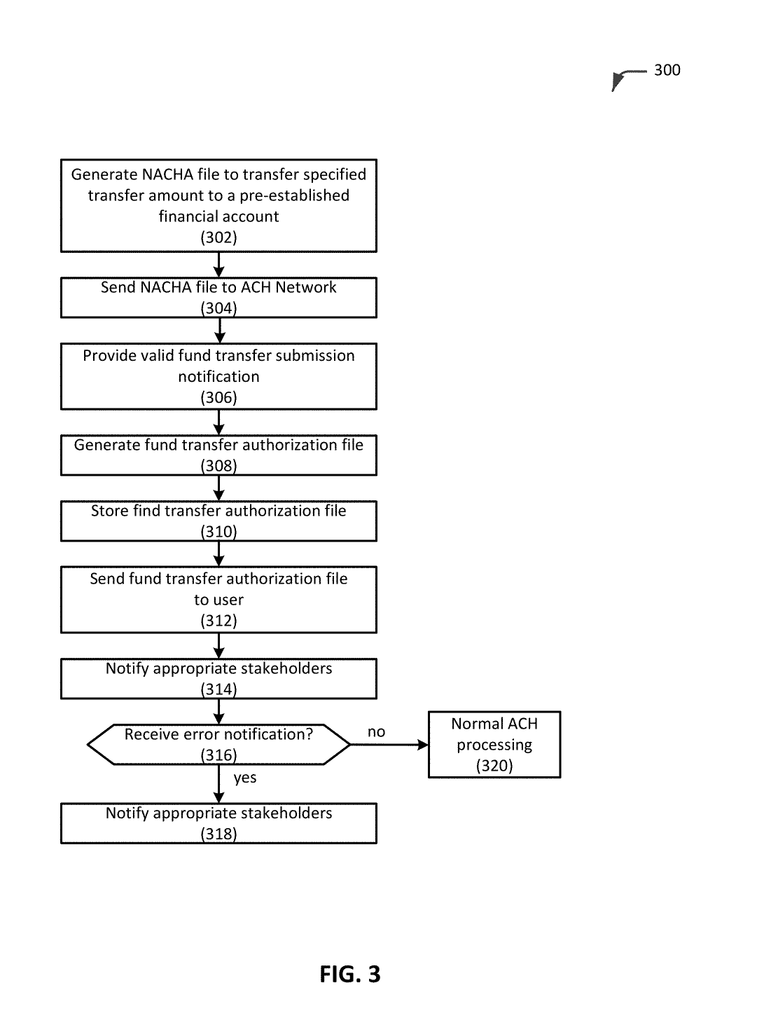

FIG. 2 is a flow diagram illustrating an example process 200 that can be used by a user to request a transfer of funds, in accordance with an embodiment of the present disclosure. FIG. 3 is a flow diagram illustrating an example process 300 for processing a transfer of funds to a pre-established financial account, in accordance with an embodiment of the present disclosure. The operations, functions, or actions illustrated in example processes 200 and 300 may in some embodiments be performed by various components of fund transfer application 118 of FIG. 1. The operations, functions, or actions described in the respective blocks of example processes 200 and 300 may also be stored as computer-executable instructions in a computer-readable medium, such as memory 110 and/or data store 116 of transaction settlement system 104 of FIG. 1.

As will be further appreciated in light of this disclosure, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

With reference to example process 200 of FIG. 2, at 202, fund transfer application 118 checks to determine whether an input is provided to or otherwise made on the fund transfer interface. By way of an example use case, a purchasing party and a selling party may have entered into a real estate transaction and agreed on a settlement date to finalize the transaction. The purchasing party and the selling party may have also agreed to use a particular settlement agent, such as Absolute Title, LLC, to close the transaction, and Absolute Title, LLC, may provide a transaction settlement system, such as transaction settlement system 104, for use by the parties to close the transaction. In this case, transaction settlement system 104 may be configured to deposit transferred funds into a pre-established financial account of Absolute Title, LLC. In this example use case, the purchasing party may use a computing device to interact with transaction settlement system 104 provided by Absolute Title, LLC. In particular, the purchasing party can access and interact with the fund transfer interface provided by user interface module 120 to transfer funds to the pre-established financial account of Absolute Title, LLC.

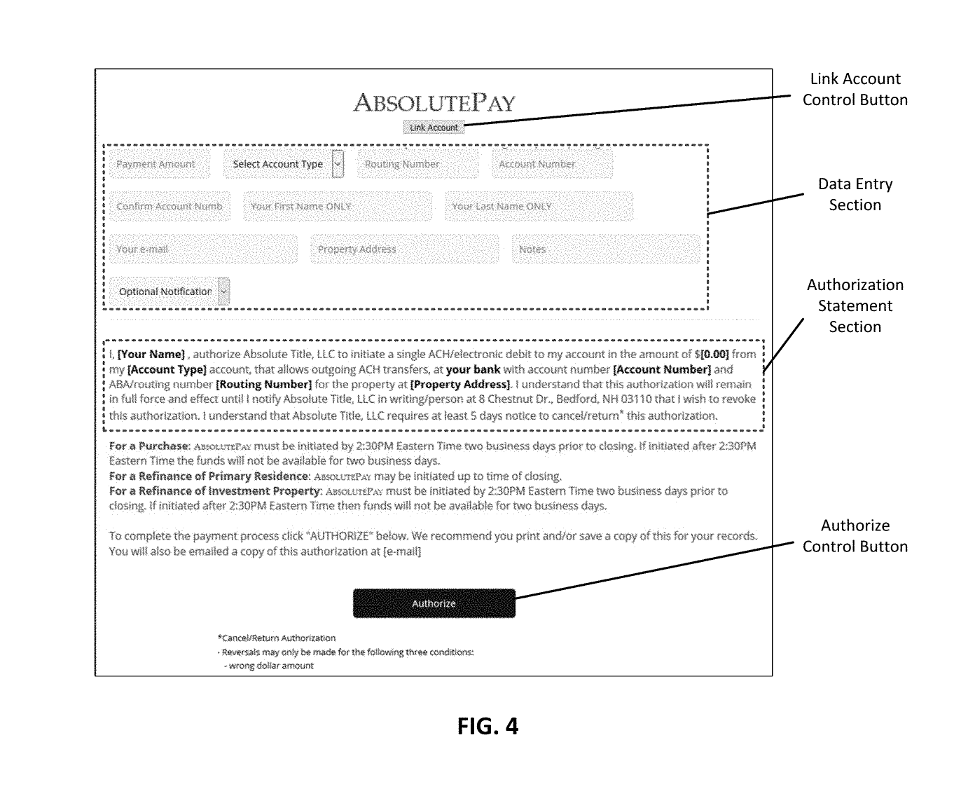

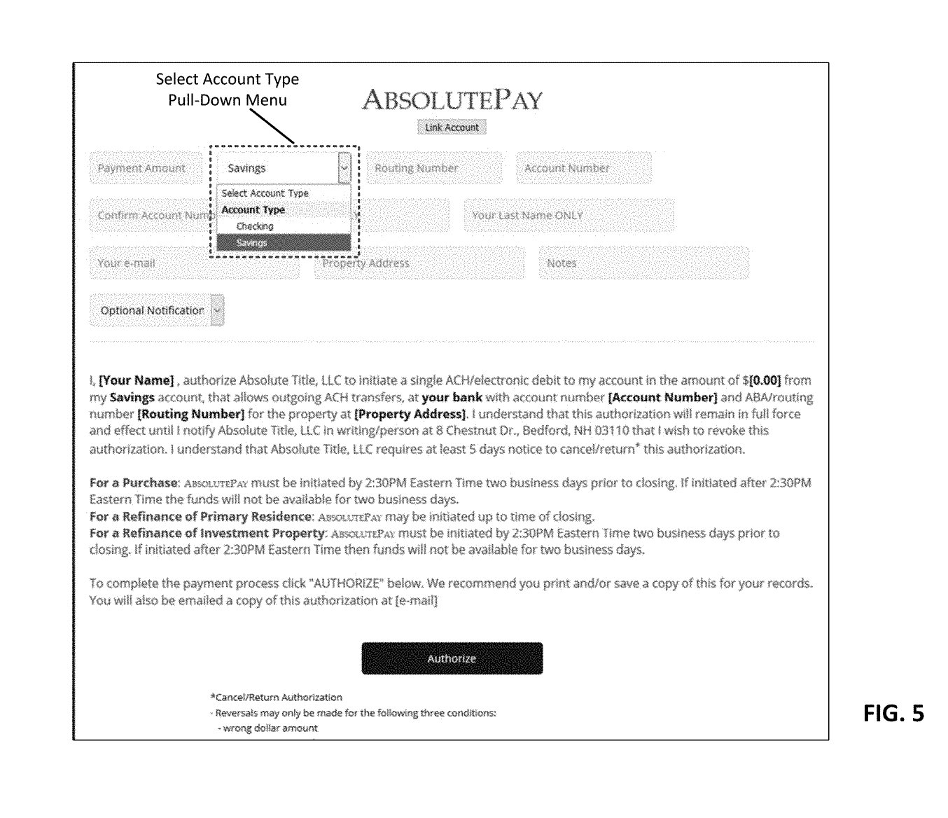

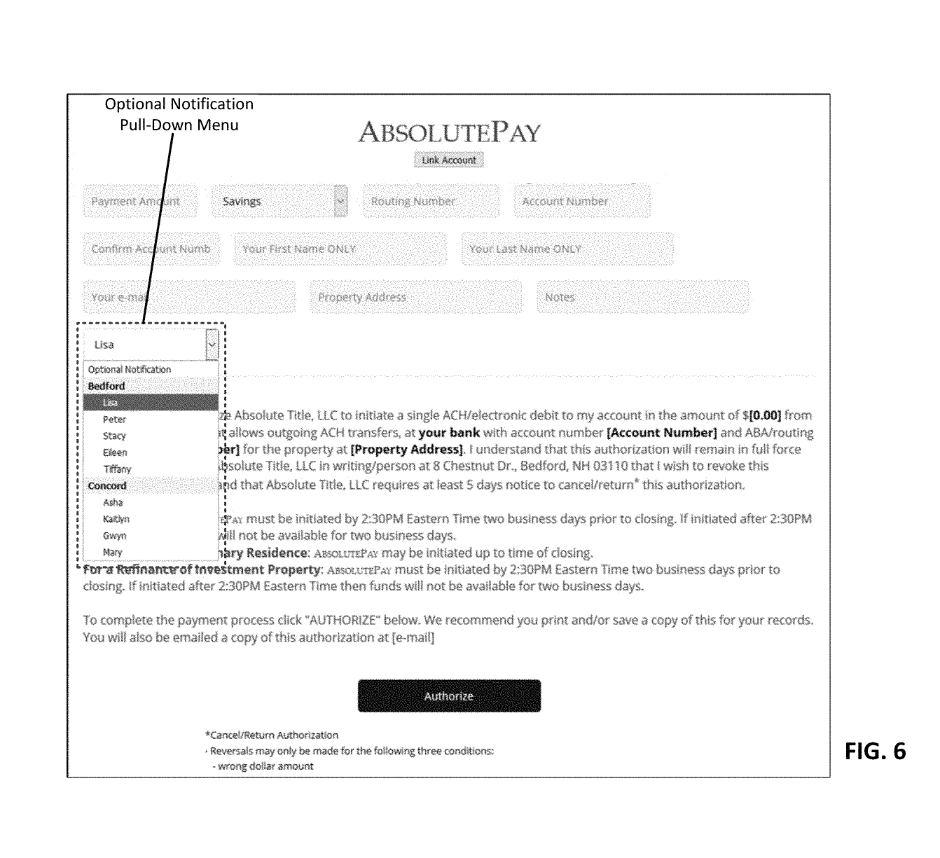

FIG. 4 is a screenshot illustrating an example fund transfer interface, in accordance with an embodiment of the present disclosure. In particular, the fund transfer interface is configured to collect information from users for initiating a transfer of funds into the pre-established financial account of Absolute Title, LLC. As shown, the fund transfer interface includes a data entry section and an authorization statement section. It is to be noted that the joint display of the data entry section and the authorization statement section within a single screen allows a user of the fund transfer interface to provide all of the information needed to authorize and initiate an electronic transfer of funds to be used within a real estate closing. By distilling the information needed into a single screen, at least some examples of the fund transfer interface provide for a more efficient and comfortable human-machine interface that is tailored to this specific application. The data entry section includes multiple fields and drop-down menus for collecting fund transfer information from a user. As can be seen in FIG. 4, the data entry section includes a payment amount field, select account type pull-down menu, routing number field, account number field, confirm account number field, first name field, last name field, email address field, property address field, notes field, and optional notification pull-down menu. The payment amount field allows the user to specify an amount of funds to transfer to the pre-established financial account of Absolute Title, LLC. The select account type pull-down menu allows the user to indicate the type of financial account specified in the account number field. In one implementation, and as illustrated in FIG. 5, the select account type pull-down menu allows for selecting either checking account or savings account. In other implementations, the select account type pull-down menu may also include other types of financial accounts, such as money market accounts, brokerage accounts, deposit accounts, and investment accounts, to name a few examples. The routing number field allows the user to specify a routing number that identifies a financial institution. In such cases, the specified routing number should identify the financial institution administering the financial account specified in the account number. The account number field allows the user to specify an account number that identifies a financial account from which to withdraw the amount of funds specified in the payment amount field. The confirm account number field allows the user to confirm the account number specified in the account number field. The first name field is for providing a first name of the user requesting the fund transfer. The last name field is for providing a last name of the user requesting the fund transfer. The email address field allows the user to specify an email address at which to receive communications from Absolute Title, LLC. The property address field allows the user to specify the address of the real estate that is being transacted (e.g., address of the property being purchased by the purchasing party). The notes field allows the user to provide any notes and/or comments regarding the fund transfer that is being requested. The optional notification pull-down menu allows the user to select additional designated parties to receive notifications and/or communications regarding the fund transfer. In one implementation, and as illustrated in FIG. 6, the optional notification pull-down menu lists the names of persons that can be selected as designated parties to receive notifications and/or communications regarding the fund transfer. For example, the persons identified in the list may be employees or agents of Absolute Title, LLC, or persons otherwise affiliated with Absolute Title, LLC, and who are authorized to work on transaction settlements. In such implementations, none, one, or more names in the list may be selected as designated parties.

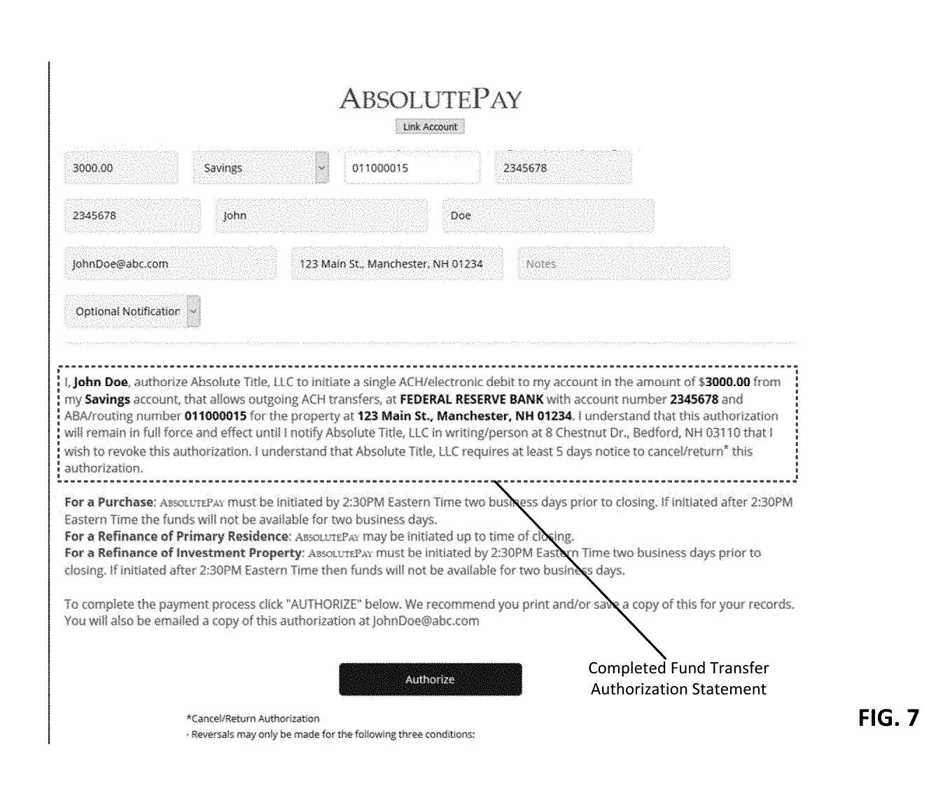

Still referring to the fund transfer interface of FIG. 4, the authorization statement section includes a fund transfer authorization statement authorizing the transfer of funds to the pre-established financial account of Absolute Title, LLC. By way of an illustrative example, and as can be seen in FIG. 4, the fund transfer authorization statement may be as follows:
I, [Your Name], authorize Absolute Title, LLC to initiate a single ACH/electronic debit to my account in the amount of $ [0.00] from my [Account Type] account, that allows outgoing ACH transfers, at your bank with account number [Account Number] and ABA/routing number [Routing Number] for the property at [Property Address]. I understand that this authorization will remain in full force and effect until I notify Absolute Title, LLC in writing/person at 8 Chestnut Dr., Bedford, N.H. 03110 that I wish to revoke this authorization. I understand that Absolute Title, LLC requires at least 5 days notice to cancel return* this authorization.
   The fund transfer authorization statement includes “placeholders” for user-provided fund transfer information, such as the name of the user authorizing the fund transfer, the amount of the fund transfer, the type of financial account being used to make the fund transfer, the account number, routing number, and name of the financial institution from which the funds are being debited (e.g., withdrawn), and the property address that is the subject of the transaction for which the fund transfer is being made. In such embodiments, the placeholders in the fund transfer authorization statement is replaced with information provided by the user in the data entry section of the fund transfer interface. In some such embodiments, the fund transfer authorization statement is updated in real-time (or near real-time) as the user is providing information in the fields or pull-down menus in the data entry section of the fund transfer interface. FIG. 7 is a screenshot illustrating the example fund transfer interface of FIG. 4 with a completed fund transfer authorization statement, in accordance with an embodiment of the present disclosure. As can be seen in FIG. 7, the completed fund transfer authorization statement includes information from or otherwise based on the data provided in the payment amount field, select account type pull-down menu, account number field, routing number field, first and last name fields, and property address field. For example, the bank name may be determined from the routing number provided in the routing number field. In some implementations, certain items of information, such as the property address and/or the bank name, may not be included in the completed fund transfer authorization statement. By way of example, in some embodiments, fund transfer application 104 may not require the user to specify a property address to request a fund transfer. In such embodiments, the user may decide to not provide a property address, in which case the completed fund transfer authorization statement will not include the property address.

Still referring to FIG. 4, the fund transfer interface also includes a link account control button. The link account control button allows a user to access a financial intuition website, such as one of the user's financial institution websites. For example, the user may use his/her credentials (e.g., userid and password or other suitable credentials) to logon to the financial institution, access his/her accounts at the financial institution, and select an account to use in performing the fund transfer. In some such embodiments, this feature is provided to users as an alternative to requiring users to manually provide certain items of fund transfer information in the data entry section of the fund transfer interface, such as an account type in the select account type pull-down menu, a routing number in the routing number field, and an account number in the account number field. In cases where the user uses the link account control button to access a financial institution website and select an account, financial account link module 122 can extract the appropriate account information (e.g., account type, routing number, and account number) from the user's financial institution website. This feature also allows users to validate account information to ensure that sufficient funds are available for the fund transfer, for instance.

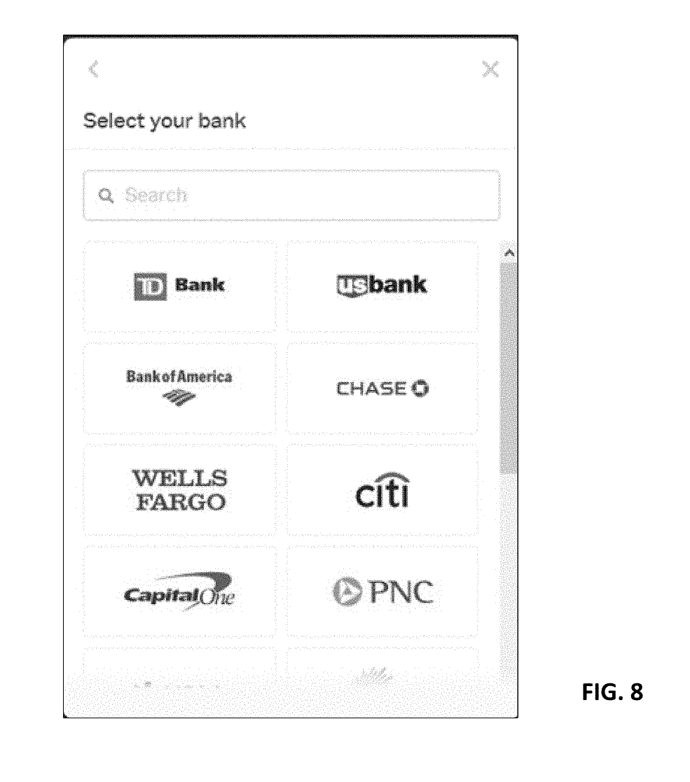

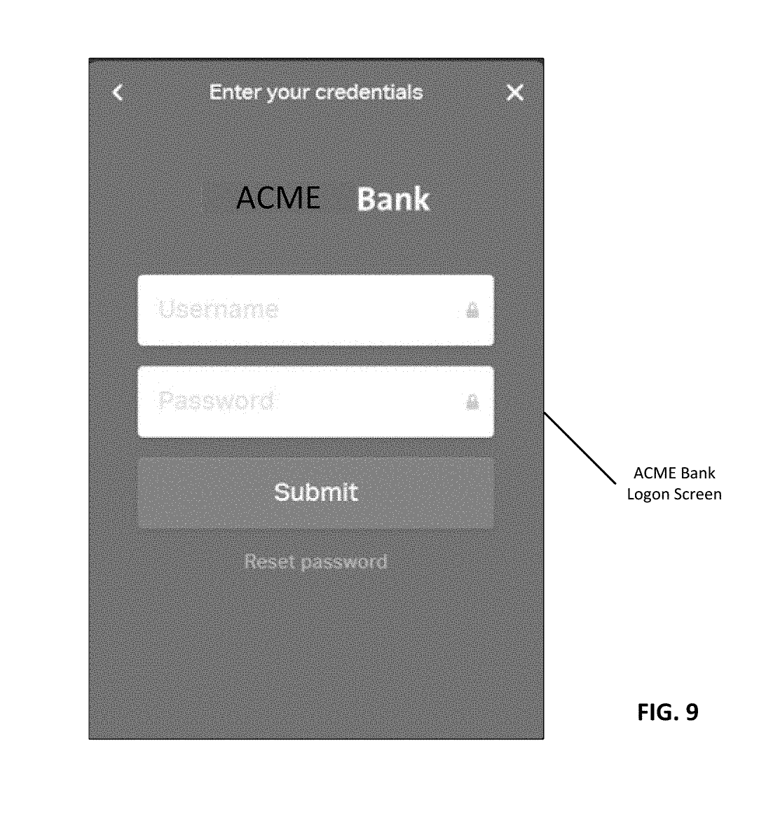

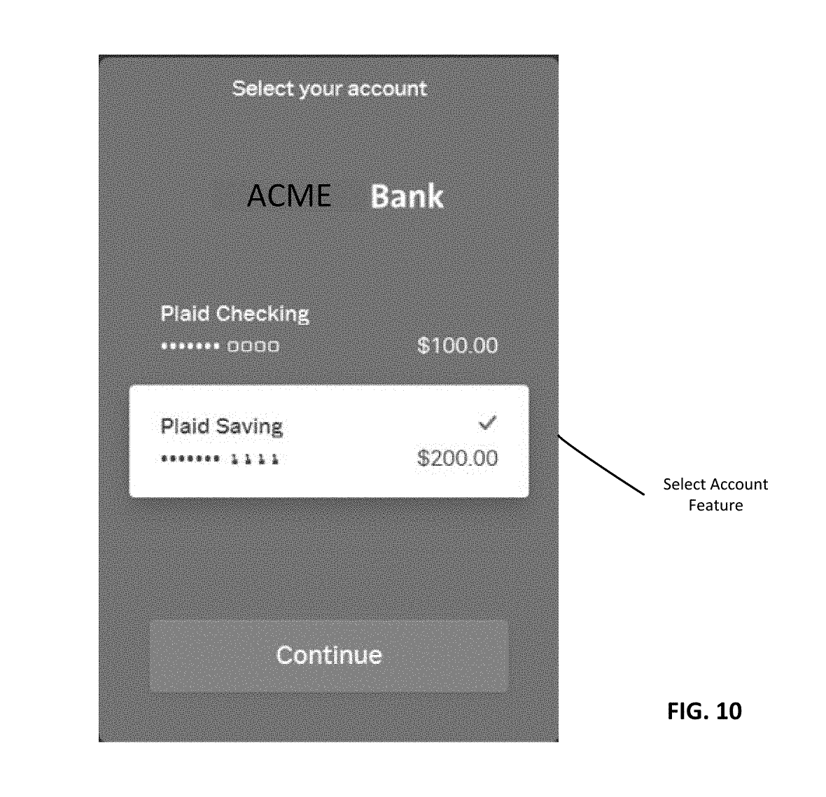

FIG. 8 is a screenshot illustrating an example link account interface, in accordance with an embodiment of the present disclosure. The user can access the link account interface by selecting the link account control button with an appropriately placed mouse-click or finger tap or other suitable user input, thereby causing user interface module 120 to present the link account interface. As shown, the link account interface includes a select bank pull-down menu that lists the names of financial institutions that can be selected. In particular, and in one implementation, financial account link module 122 can provide access to and extract account information from the websites of the financial institutions listed in the select bank pull-down menu. The user can then select a financial institution from the list of financial institutions provided in the select bank pull-down menu to access a logon screen for the selected financial institution. Assuming, for example, that the user selects ACME Bank from the list of financial institutions, user interface module 120 may present a logon screen interface for ACME Bank, as illustrated in FIG. 9. The logon screen interface for ACME Bank allows the user to logon to ACME Bank by providing the necessary credentials. As can be seen in FIG. 9, the user can logon to ACME Bank by providing a username and password. Once the user provides the requested credentials, such as the username and password, user interface module 120 may present an account selection interface for ACME Bank, as illustrated in FIG. 10. The account selection interface includes a select account feature that lists the user's accounts with the financial institution that are available for use in performing the fund transfer and, for each account, the account balance. The select account feature allows the user to select one of the listed accounts for use in performing the fund transfer, thereby causing the amount of funds to transfer to be debited from the selected account. For example, as shown in FIG. 10, the select account feature indicates that the user has a plaid checking account and a plaid saving account with ACME Bank. The select account feature also indicates an account balance of $100.00 in the plaid checking account, and an account balance of $200.00 in the plaid saving account. As can be further seen in FIG. 10, the plaid savings account has been selected for use in performing the fund transfer.

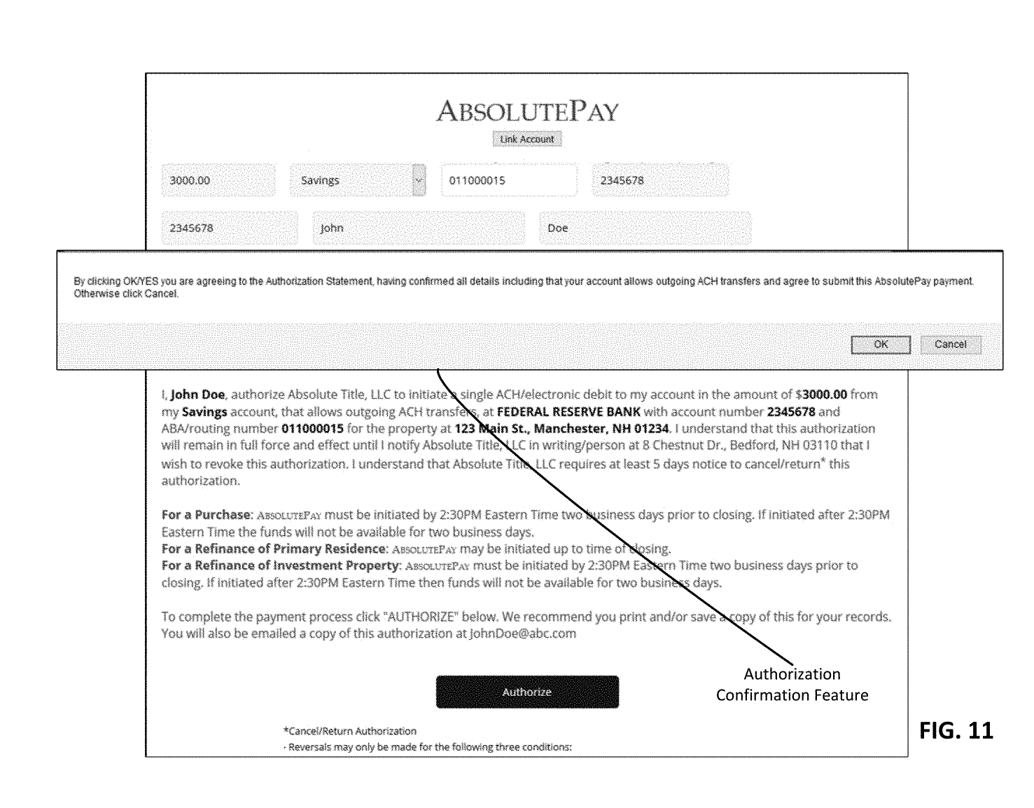

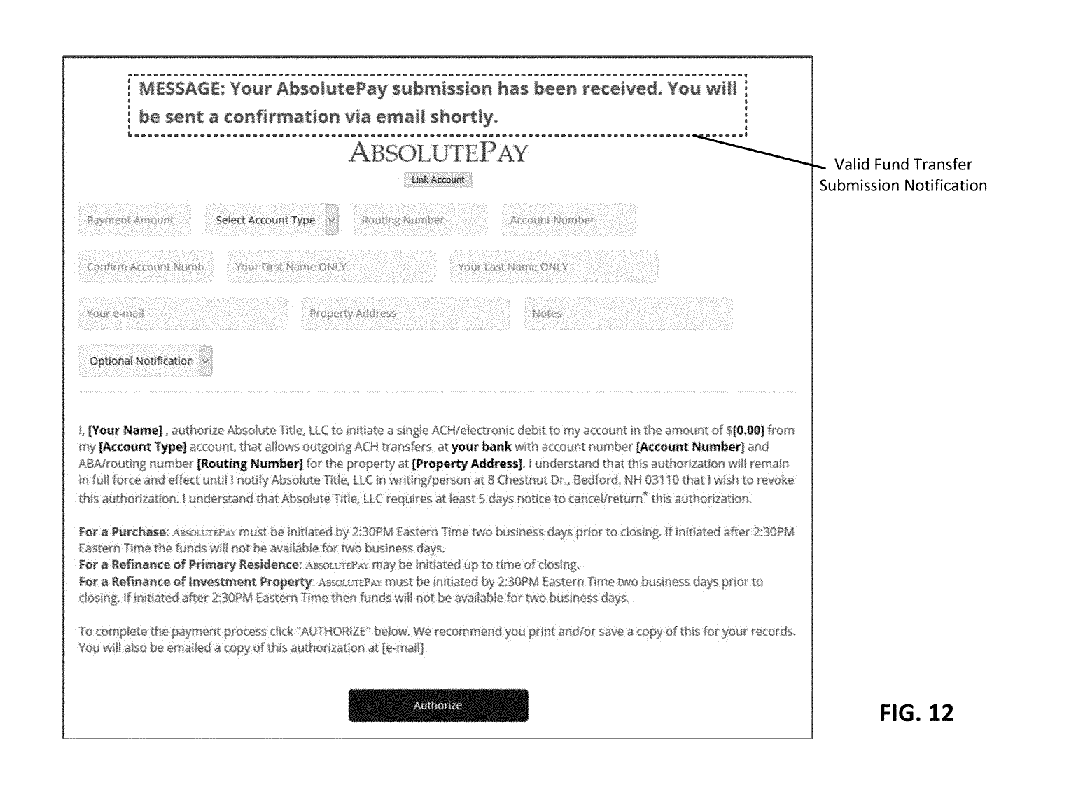

Still referring to FIG. 4, the fund transfer interface also includes an authorize control button. The authorize control button allows a user to initiate a transfer of funds to the pre-established financial account based on the information provided in the data entry section of the fund transfer interface. When ready to request the fund transfer, the user can select the authorize control button with an appropriately placed mouse-click or finger tap or other suitable user input, thereby causing user interface module 120 to present an authorization confirmation feature, as illustrated in FIG. 11. As can be seen in FIG. 11, the authorization confirmation feature includes a summary statement describing the action (e.g., fund transfer) the user is authorizing, and allows the user to either confirm or cancel the authorization (e.g., authorization for the fund transfer). Once the user confirms the authorization, for example by selecting the confirm control button included in the authorization confirmation feature, user interface module 120 may present a valid fund transfer submission notification, as illustrated in FIG. 12. As can be seen in FIG. 12, the valid fund transfer submission notification informs the user that the requested fund transfer has been received and that the user can expect to receive a confirmation via an email message to the email address provided in the email field in the data entry section of the fund transfer interface.

Referring again to example process 200 of FIG. 2 and continuing the above example use case, at 202, fund transfer application 118 may determine that the purchasing party has selected the link account control button, made an input to a field or pull-down menu in the data entry section of the fund transfer interface, or selected the authorize control button. If it is determined that the link account control button is selected at 202, then, at 204, financial account link module 122 links or otherwise communicatively couples to the financial account selected by the purchasing party. In one example implementation and as described previously, the purchasing party may have utilized the interfaces provided by user interface module 120, such as the link account interface, the logon screen interface, and the account selection interface, to logon to their financial institution and select an account to use in the fund transfer.

At 206, financial account link module 122 retrieves or otherwise extracts the financial account information of the account selected by the purchasing party. In one implementation, financial account link module 122 can retrieve the financial account information using the purchasing party's login session with their financial institution. The financial account information may include, for example, the account type, routing number, and account number of the selected account.

At 208, financial account link module 122 populates the appropriate fields in the data entry section of the fund transfer interface using the retrieved financial account information. For example, financial account link module 122 can indicate the account type in the account type pull-down menu, provide the routing number in the routing number field, and provide the account number in the account number and confirm account number fields. This allows the purchasing party to verify the financial account information. For example, the purchasing party may verify that the account information indicated the corresponding fields and pull-down menu is in fact the account to use in performing the fund transfer. Note that the purchasing party may change the account type, routing number, and account number indicated in the fields and the pull-down menu.

At 210, financial account link module 122 updates the fund transfer authorization statement that is being displayed in the authorization statement section of the fund transfer interface using the retrieved financial account information. For example, the retrieved financial account information can be included in the fund transfer authorization statement, as appropriate.

At 212, fund transfer application 118 can continue processing inputs provided to or otherwise made on the fund transfer interface. For example, and in one implementation, fund transfer application 118 can return to 202 and check to determine whether another input is provided to or otherwise made on the fund transfer interface.

Otherwise, if it is determined that an input to a field or pull-down menu in the data entry section of the fund transfer interface is made at 202, then, at 214, transaction request processing module 124 validates the data input to the field or pull-down menu. For example, in the case of data input to the payment amount field, transaction request processing module 124 can check to determine that the value entered is a numerical value. In one embodiment, transaction request processing module 124 can check to determine that the value entered in the payment amount field does not exceed a maximum threshold value, such as $650,000.00, $700,000.00, $750,000.00, $800,000.00, or any other suitable threshold value. In some such embodiments, the maximum threshold value may be tunable and specified by the provider of transaction settlement system 104, such as Absolute Title, LLC, for instance. In some embodiments, transaction request processing module 124 can check to determine that the value entered in the payment amount field does not exceed the available balance in the account specified in the account number field. For instance, this check may be performed in instances where the purchasing party uses the link account control button and accesses his/her financial account information. In such cases, financial account link module 122 can extract the account balance, and transaction request processing module 124 can check the value entered in the payment amount field against the extracted account balance.

Referring still to 214, in the case of data input to the routing number field, transaction request processing module 124 can check to determine that a number is entered and that the entered number is a valid routing number. For example, the number entered in the routing number field can be checked against a routing number database, such as The Federal Bank Routing Number Directory, to determine whether the number is a valid routing number. In the case of data input to the account number field, transaction request processing module 124 can check to determine that a number is entered. In the case of data input to the verify account number field, transaction request processing module 124 can check to determine that a number is entered and that the entered number matches the number in the account number field. In the case of data input to the email address field, transaction request processing module 124 can check to determine that the data entered is in the proper form for a valid email address (e.g., “local-part@domain”).

At 216, transaction request processing module 124 determines whether the data input to the field or pull-down menu is validated. If the input data is validated, then, at 218, transaction request processing module 124 updates the fund transfer authorization statement that is being displayed in the authorization statement section of the fund transfer interface using the validated data. For example, in the case of the input data being the name of the user requesting the fund transfer, the name can be included in the fund transfer authorization statement. In the case of the input data being the routing number, the routing number can be included in the fund transfer authorization statement. In some such cases, the routing number can be used to identify a bank or financial institution, and the name of the identified bank or financial institution can be included in the fund transfer authorization statement. Fund transfer application 118 can then continue processing inputs provided to or otherwise made on the fund transfer interface at 212.

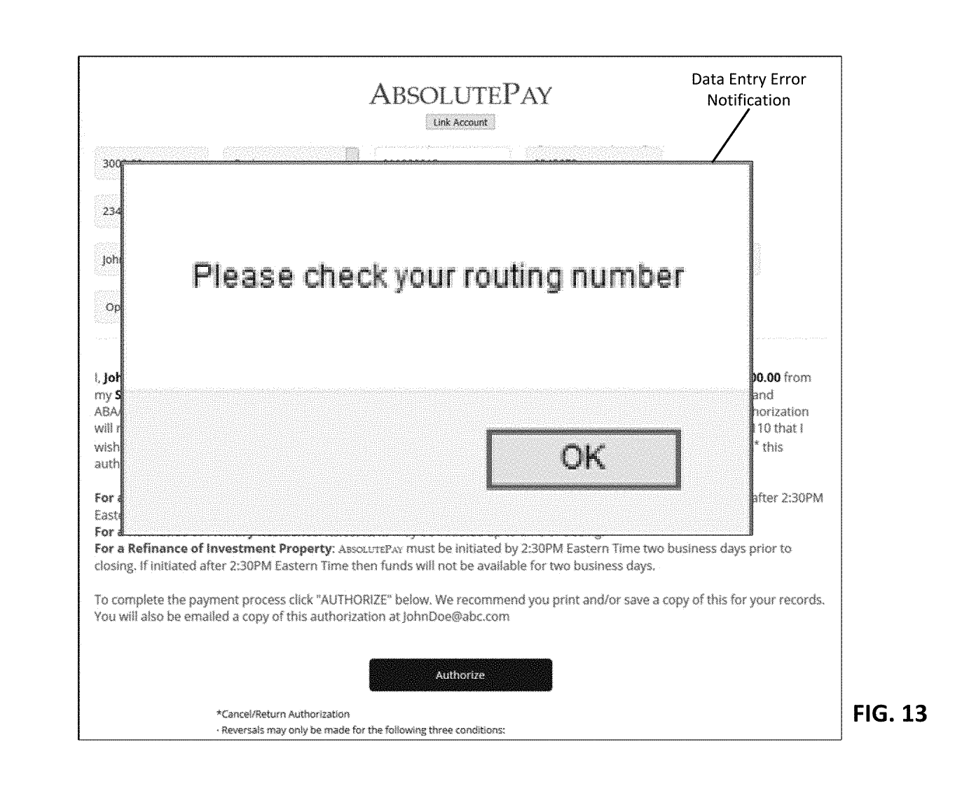

Otherwise, if the input data is not validated, then, at 220, transaction request processing module 124 provides an error notification informing of the data entry error. FIG. 13 is a screenshot illustrating an example data entry error notification, in accordance with an embodiment of the present disclosure. In particular, the data entry error notification shown in FIG. 13 informs of an error in the routing number input to the routing number field. In one implementation, transaction request processing module 124 can also provide suggestions as to correcting the data entry error. Fund transfer application 118 can then continue processing inputs provided to or otherwise made on the fund transfer interface at 212.

Otherwise, if it is determined that the authorize control button is selected at 202, then, at 222, transaction request processing module 124 checks to determine whether the information necessary to perform a fund transfer has been provided by the purchasing party. In one implementation, in order to initiate a fund transfer, transaction request processing module 124 may require a name of the user requesting the fund transfer, an indication of the amount of funds to transfer, a routing number, and an account number.

If the information necessary to perform a fund transfer is not provided, then, at 224, transaction request processing module 124 provides an error notification informing that the requested fund transfer cannot be initiated. In one implementation, transaction request processing module 124 can also provide an indication of the information that is missing and necessary to request a fund transfer. Fund transfer application 118 can then continue processing inputs provided to or otherwise made on the fund transfer interface at 212.

Otherwise, if the information necessary to perform a fund transfer is provided, then, at 226, transaction request processing module 124 requests a confirmation of the authorization. For example, and in one implementation, transaction request processing module 124 can present an authorization confirmation feature as illustrated in FIG. 11. The authorization confirmation feature can then be used to confirm (or cancel) the authorization.

If the authorization is confirmed, then, at 230, fund transfer application 118 processes the requested fund transfer. FIG. 3 provides further details of processes the requested fund transfer at 230, according to some embodiments. Otherwise, if the authorization is not confirmed (e.g., canceled), fund transfer application 118 can then continue processing inputs provided to or otherwise made on the fund transfer interface at 212.

With reference to example process 300 of FIG. 3, at 302, NACHA processing module 126 generates a NACHA file to transfer the specified amount of funds to a pre-established financial account. The NACHA file conforms to the NACHA specification for executing an ACH payment transaction. In particular, the ACH payment transaction transfers a specified amount of funds from a source account to a destination account. The amount of funds to transfer is the amount specified in the payment amount field, the source account is the financial account identified by the account number specified in the account number field, and the destination account is the pre-established financial account. Continuing the above example use case, the amount of funds to transfer and the source account (the account from which to debit the amount of funds that is being transferred) is specified by purchasing party, and the pre-established financial account is a financial account of Absolute Pay, LLC.

At 304, NACHA processing module 126 sends or otherwise provides the NACHA file to the ACH Network for processing. In particular, the ACH Network processes the payment transaction as defined by the NACHA file. At 306, NACHA processing module 126 provides a valid fund transfer submission notification. For example, and in one implementation, NACHA processing module 126 can present a valid fund transfer submission notification as illustrated in FIG. 12.

At 308, NACHA processing module 126 generates a fund transfer authorization file. The fund transfer authorization file includes a completed fund transfer authorization statement from the authorization statement section of the fund transfer interface. At 310, NACHA processing module 126 stores the fund transfer authorization file. For example, regulations may require the safekeeping of such authorizations for a pre-determined length of time.

At 312, NACHA processing module 126 sends or causes to be sent the fund transfer authorization file to the user that requested the fund transfer. For example, and in one implementation, the fund transfer authorization file can be sent as an attachment to an email sent to the email address specified in the email address field. The email can also include a notification of the initiated fund transfer.

At 314, NACHA processing module 126 notifies the appropriate stakeholders of the initiated fund transfer. The appropriate stakeholders can include the user and the designated parties selected in the optional notification pull-down menu. In such embodiments, the notifications can be by email, text message, online chat, or other suitable digital communication. In some such embodiments, the notification to the stakeholders can also include the notes and/or comments from the notes field.

At 316, NACHA processing module 126 checks for receipt of an error notification from the ACH Network. If an error notification is received, then, at 318, NACHA processing module 126 notifies the appropriate stakeholders of the error in performing the fund transfer request. For example, NACHA processing module 126 can inform the user that requested the fund transfer and any other stakeholder of the problem with the fund transfer request. Otherwise, at 320, NACHA processing module 126 assumes that the summitted NACHA file is being normally processed. In some embodiments, NACHA processing module 126 can periodically check the pre-established financial account for a deposit of the amount of funds that is being transferred by the NACHA file.

In some embodiments, additional operations are performed. For example, in one embodiment, fund transfer application 118 maintains a record of the fund transfer into the pre-established financial account. For example, and in one implementation, upon verifying the deposit into the pre-established financial account, fund transfer application 118 can maintain a record that associates the user that requested the fund transfer and the amount of funds transferred. In other implementations, the record may also associate other items of fund transfer information such as the property address, for example.

### Further Example Embodiments

The following examples pertain to further embodiments, from which numerous permutations and configurations will be apparent.

Example 1 is a computer program product including one or more non-transitory machine-readable mediums encoding instructions that when executed by one or more processors cause a process to be carried out to transfer funds, the process including: receiving, via a first field in a fund transfer interface, an amount of funds to transfer; receiving, via a second field in the fund transfer interface, a routing number, wherein the routing number identifies a financial institution; receiving, via a third field in the fund transfer interface, an account number, wherein the account number identifies a financial account; receiving authorization for a fund transfer based on the amount of funds to transfer, the routing number, and the account number; generating a NACHA file that defines a payment transaction, wherein the payment transaction transfers the amount of funds from the financial account identified by the account number to a pre-established financial account; and causing submission of the payment transaction for processing.

Example 2 includes the subject matter of Example 1, wherein causing submission of the payment transaction for processing includes causing submission of the NACHA file to an ACH Network.

Example 3 includes the subject matter of any of Examples 1 and 2, wherein the routing number is retrieved from the financial institution.

Example 4 includes the subject matter of any of Examples 1 through 3, wherein the account number is retrieved from the financial institution.

Example 5 includes the subject matter of any of Examples 1 through 4, wherein the fund transfer interface includes a fund transfer authorization statement authorizing the transfer of the amount of funds from the financial account identified by the account number to the pre-established financial account.

Example 6 includes the subject matter of any of Examples 1 through 5, wherein the pre-established financial account is a financial account of a real estate transaction settlement agent.

Example 7 includes the subject matter of any of Examples 1 through 6, wherein the financial institution is a bank.

Example 8 includes the subject matter of any of Examples 1 through 7, wherein the financial account is a checking account.

Example 9 includes the subject matter of any of Examples 1 through 7, wherein the financial account is a saving account.

Example 10 includes the subject matter of any of Examples 1 through 9, wherein the fund transfer interface comprises a link account control button.

Example 11 includes the subject matter of Example 10, wherein the process further includes, in response to determination of a selection of the link account control button, causing rendering of a link account interface.

Example 12 includes the subject matter of any of Examples 1 through 11, wherein the process further includes, in response to determination of an error in processing the payment transaction, causing sending of an error notification to an authorizer of the payment transaction.

Example 13 is a is a computer implemented method to transfer funds, the method including: receiving, via a first field in a fund transfer interface, an amount of funds to transfer; receiving, via a second field in the fund transfer interface, a routing number, wherein the routing number identifies a financial institution; receiving, via a third field in the fund transfer interface, an account number, wherein the account number identifies a financial account; receiving authorization for a fund transfer based on the amount of funds to transfer, the routing number, and the account number; generating a NACHA file that defines a payment transaction, wherein the payment transaction transfers the amount of funds from the financial account identified by the account number to a pre-established financial account; and causing submission of the payment transaction for processing.

Example 14 includes the subject matter of Example 13, wherein causing submission of the payment transaction for processing includes causing submission of the NACHA file to an ACH Network.

Example 15 includes the subject matter of any of Examples 13 and 14, wherein one or both of the routing number and account number is retrieved from the financial institution.

Example 16 includes the subject matter of any of Examples 13 through 15, wherein the fund transfer interface includes a fund transfer authorization statement authorizing the transfer of the amount of funds from the financial account identified by the account number to the pre-established financial account.

Example 17 includes the subject matter of any of Examples 13 through 16, wherein the financial account is a checking account or a saving account.

Example 18 includes the subject matter of any of Examples 13 through 17, wherein the fund transfer interface includes a link account control button, the method further including, in response to determination of a selection of the link account control button, causing rendering of a link account interface.

Example 19 includes the subject matter of any of Examples 13 through 18, further including, in response to determination of an error in processing the payment transaction, causing sending of an error notification to an authorizer of the payment transaction.

Example 20 is a system to transfer funds. The system includes one or more non-transitory machine-readable mediums configured to store instructions, and one or more processors configured to execute the instructions stored on the one or more non-transitory machine-readable mediums. Execution of the instructions causes the one or more processors to: cause a fund transfer interface to be rendered, the fund transfer interface includes a data entry section, an authorization statement section, an authorize control button, and a link account control button; receive, via data entry in the data entry section, an amount of funds to transfer; receive, via data entry in the data entry section, a routing number, wherein the routing number identifies a financial institution; receive, via data entry in the data entry section, an account number, wherein the account number identifies a financial account; receive, via the authorize control button, authorization for a fund transfer based on the amount of funds to transfer, the routing number, and the account number; generate a NACHA file that defines a payment transaction, wherein the payment transaction transfers the amount of funds from the financial account identified by the account number to a pre-established financial account; and cause submission of the payment transaction for processing.

Example 21 includes the subject matter of Example 20, wherein execution of the instructions causes the one or more processors to, in response to determination of a selection of the link account control button, cause a link account interface to render.

Example 22 includes the subject matter of any of Examples 20 and 21, wherein to cause submission of the payment transaction for processing includes cause submission of the NACHA file to an ACH Network.

Example 23 includes the subject matter of any of Examples 20 through 22, wherein the routing number is retrieved from the financial institution.

Example 24 includes the subject matter of any of Examples 20 through 23, wherein the account number is retrieved from the financial institution.

Example 25 includes the subject matter of any of Examples 20 through 24, wherein the authorization statement section includes a fund transfer authorization statement authorizing the transfer of the amount of funds from the financial account identified by the account number to the pre-established financial account.

Example 26 includes the subject matter of any of Examples 20 through 25, wherein the pre-established financial account is a financial account of a real estate transaction settlement agent.

Example 27 includes the subject matter of any of Examples 20 through 26, wherein the financial institution is a bank.

Example 28 includes the subject matter of any of Examples 20 through 27, wherein the financial account is a checking account.

Example 29 includes the subject matter of any of Examples 20 through 27, wherein the financial account is a saving account.

Example 30 includes the subject matter of any of Examples 20 through 29, wherein execution of the instructions causes the one or more processors to, in response to determination of an error in processing the payment transaction, cause to be sent an error notification to an authorizer of the payment transaction.

Having thus described several aspects of at least one example, it is to be appreciated that various alterations, modifications, and improvements will readily occur to those skilled in the art. For instance, examples disclosed herein may also be used in other contexts, such as refinancing (owner-to-bank) transfers, escrow-to-agent transfers, and escrow-to-seller transfers. Such alterations, modifications, and improvements are intended to be part of this disclosure, and are intended to be within the scope of the examples discussed herein. Accordingly, the foregoing description and drawings are by way of example only.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended to be pedagogical examples to aid the reader in understanding the present disclosure and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A computer program product including one or more non-transitory machine-readable mediums encoding instructions that when executed by one or more processors cause a process to be carried out to transfer funds, the process comprising:
receiving, via a first field in a fund transfer interface, an amount of funds to transfer;
receiving, via a second field in the fund transfer interface, a routing number, wherein the routing number identifies a financial institution;
receiving, via a third field in the fund transfer interface, an account number, wherein the account number identifies a financial account;
receiving authorization for a fund transfer based on the amount of funds to transfer, the routing number, and the account number;
generating a NACHA file that defines a payment transaction, wherein the payment transaction transfers the amount of funds from the financial account identified by the account number to a pre-established financial account; and
causing submission of the payment transaction for processing.

2. The computer program product of claim 1, wherein causing submission of the payment transaction for processing comprises causing submission of the NACHA file to an ACH Network.

3. The computer program product of claim 1, wherein the routing number is retrieved from the financial institution.

4. The computer program product of claim 1, wherein the account number is retrieved from the financial institution.

5. The computer program product of claim 1, wherein the fund transfer interface includes a fund transfer authorization statement authorizing the transfer of the amount of funds from the financial account identified by the account number to the pre-established financial account.

6. The computer program product of claim 1, wherein the pre-established financial account is a financial account of a real estate transaction settlement agent.

7. The computer program product of claim 1, wherein the financial institution is a bank.

8. The computer program product of claim 1, wherein the financial account is a checking account.

9. The computer program product of claim 1, wherein the financial account is a saving account.

10. The computer program product of claim 1, wherein the fund transfer interface comprises a link account control button.

11. The computer program product of claim 10, wherein the process further comprises, in response to determination of a selection of the link account control button, causing rendering of a link account interface.

12. The computer program product of claim 1, wherein the process further comprises, in response to determination of an error in processing the payment transaction, causing sending of an error notification to an authorizer of the payment transaction.

13. A computer implemented method to transfer funds, the method comprising:
receiving, via a first field in a fund transfer interface, an amount of funds to transfer;
receiving, via a second field in the fund transfer interface, a routing number, wherein the routing number identifies a financial institution;
receiving, via a third field in the fund transfer interface, an account number, wherein the account number identifies a financial account;
receiving authorization for a fund transfer based on the amount of funds to transfer, the routing number, and the account number;
generating a NACHA file that defines a payment transaction, wherein the payment transaction transfers the amount of funds from the financial account identified by the account number to a pre-established financial account; and
causing submission of the payment transaction for processing.

14. The method of claim 13, wherein causing submission of the payment transaction for processing comprises causing submission of the NACHA file to an ACH Network.

15. The method of claim 13, wherein one or both of the routing number and the account number is retrieved from the financial institution.

16. The method of claim 13, wherein the fund transfer interface includes a fund transfer authorization statement authorizing the transfer of the amount of funds from the financial account identified by the account number to the pre-established financial account.

17. The method of claim 13, wherein the fund transfer interface comprises a link account control button, the method further comprising, in response to determination of a selection of the link account control button, causing rendering of a link account interface.

18. The method of claim 13, further comprising, in response to determination of an error in processing the payment transaction, causing sending of an error notification to an authorizer of the payment transaction.

19. A system to transfer funds, the system comprising:
one or more non-transitory machine-readable mediums configured to store instructions; and
one or more processors configured to execute the instructions stored on the one or more non-transitory machine-readable mediums, wherein execution of the instructions causes the one or more processors to
cause a fund transfer interface to be rendered, the fund transfer interface comprising a data entry section, an authorization statement section, an authorize control button, and a link account control button;
receive, via data entry in the data entry section, an amount of funds to transfer;
receive, via data entry in the data entry section, a routing number, wherein the routing number identifies a financial institution;
receive, via data entry in the data entry section, an account number, wherein the account number identifies a financial account;
receive, via the authorize control button, authorization for a fund transfer based on the amount of funds to transfer, the routing number, and the account number;
generate a NACHA file that defines a payment transaction, wherein the payment transaction transfers the amount of funds from the financial account identified by the account number to a pre-established financial account; and
cause submission of the payment transaction for processing.

20. The system of claim 19, wherein execution of the instructions causes the one or more processors to, in response to determination of a selection of the link account control button, cause a link account interface to render.
